(19) United States
(12) Patent Application Publication
(10) Pub. No.: US 2010/0170603 A1
(43) Pub. Date: Jul. 8, 2010

(54) Easily mountable and removable universally adjustable traction apparatus for vehicle tires

(76) Inventor: Frank L. Polyakovics, Milpitas, CA (US)

Correspondence Address: JONES, TULLAR & COOPER, P.C., P.O. BOX 2266 EADS STATION, ARLINGTON, VA, 22202, US

(21) Appl. No.: 12/150,454

(22) Filed: Apr. 29, 2008

(51) Int. Cl. B60C 27/04

(52) U.S. Cl. 152/225 R

(57) ABSTRACT

The primary difficulty with equipment applicable to automobile tires to increase traction on snow-covered ground is mounting the equipment to the tire. The subject apparatus includes a base plate having multiple radially extending slots within which are slidably mounted radially extending rods to which are attached tire engaging claw members that overlap the periphery of the tire. A control plate is mounted onto the base plate and a gear mechanism is mounted between the two plates so that the gear mechanism may be operated to draw the claws inwardly to impose a retention pressure on the periphery of the tire. Means are provided to lock the apparatus in a tire tread engaging position. To remove the apparatus, the locking means are released and the claws are radially extended away from the tire so that the entire assembly may be removed from the tire.

### FIELD OF THE INVENTION

This invention relates essentially to a fully assembled apparatus that may easily be attached to vehicle tires without the need of raising the tires off the ground or supporting surface, be it sand, snow or mud.

### DESCRIPTION OF THE PRIOR ART

Various designs of tires have been produced to augment traction in wet, slushy or snow conditions. Some of these include tread designs alleged to provide added traction. Others include the placement of metal studs in tires to provide added traction, but these stud-equipped tires require tedious removal and replacement by conventional tread tires when road conditions no longer demand stud-equipped tires. Chains have been applied to tires to increase traction, but these are difficult to apply, frequently wear thin and break, and are difficult to remove. Examples of other devices that have been developed to provide added traction are shown in the United States patents listed hereinafter.

| U.S. Pat. No. | Issue Date | U.S. Class |
|---|---|---|
| 2,873,783 | Feb. 17, 1959 | 152-218 |
| 3,019,830 | Feb. 06, 1962 | 152-225 |
| 3,249,143 | May 03, 1966 | 152-225 |
| 3,283,796 | Nov. 08, 1966 | 152-218 |
| 4,122,880 | Oct. 31, 1978 | 152-216 |
| 4,209,049 | Jun. 24, 1980 | 152-225 |
| 4,306/604 | Dec. 22, 1981 | 152-225 |
| 4,405,006 | Sep. 20, 1983 | 152-170 |
| 4.549.591 | Oct. 29, 1985 | 152-218 |
| 4,862,936 | Sep. 05, 1989 | 152-216 |
| 5,012,848 | May 07, 1991 | 152-218 |
| 5,156.695 | Oct. 20, 1992 | 152-216 |
| 5,223,058 | Jun. 29, 1993 | 152-216 |
| 5,540,267 | Jul. 30, 1996 | 152-216 |
| 5.654.659 | Jul. 08, 1997 | 152-216 |
| 5,735,980 | Apr. 07, 1998 | 152-216 |
| 6,341,635 | Jan. 29, 2002 | 152-225 |
| 6.450.224 | Sep. 17, 2002 | 152-218 |
| 6,619,353 | Sep. 16, 2003 | 152-225 R |
| 6,802,349 | Oct. 12, 2004 | 152-225 R |

Although the traction enhancing devices of the prior art listed above fulfill their intended purpose, they do so at a cost that is believed to be prohibitive because of their complexity of manufacture and difficulty of application and removal from the tires with which they are associated.

### OBJECTS OF THE INVENTION

Because of the number of female drivers in our present society and the general lack of mechanical aptitude of many males and most female drivers, there is a need for a traction device for tires that is a complete assembly ready for detachable attachment directly to a tire mounted on a wheel and with the tire resting on a supporting surface without the need to jack up the vehicle to elevate the tire above the supporting surface.

To this end, it is an object of the present invention to provide a traction apparatus assembly that may be packaged in a container easily stored in a vehicle and ready for easy assembly and immediate installation on a vehicle tire when the need arises and which can be as easily and quickly removed from the tire when it is no longer needed.

Another object of the invention is the provision of a vehicle tire traction apparatus that is mountable on and demountable from a vehicle tire without the need to lift the tire from the supporting surface on which the tire is resting.

A still further object of the invention is the provision of a vehicle tire traction apparatus that may be easily and quickly attached to a tire mounted on a wheel without the need to mount the apparatus directly to the wheel on which the tire is mounted.

Yet another object of the invention is the provision of a vehicle tire traction apparatus that includes adjustment means manipulable to accommodate a variety of sizes of vehicle tires.

A still further object of the invention is the provision of a vehicle traction apparatus designed to increase engagement force with the tire when the vehicle moves forward or backward.

The invention possesses other objects and features of advantage, some of which, along with the foregoing, will be apparent from the accompanying description and the drawings.

### BRIEF DESCRIPTION OF THE DRAWINGS

FIG. 1 is a perspective view illustrating the tire traction enhancing apparatus'in complete assembly, shown apart from a tire on which it is intended to be detachably mounted.

FIG. 2 is a perspective view of the traction enhancing apparatus control plate adapted for superimposition in axial alignment over the base plate illustrated in FIG. 1.

FIG. 2A is a perspective view of the base plate shown apart from the control plate of FIG. 2 and provided with eight radially extending channel guide members circumferentially evenly spaced and attached to the base plate.

FIG. 3 is a perspective view of a left-handed gear control mechanism shown apart from the assembly illustrated in FIG. 1.

FIG. 3A is a fragmentary perspective view of a portion of the base plate with a tire engagement claw member attached thereto.

FIG. 4 is a perspective view of a tire engagement claw member shown apart from the apparatus.

FIG. 4A is a perspective view of a right-handed gear control mechanism shown apart from the assembly illustrated in FIG. 1.

FIG. 5 is a perspective view of the slidably adjustable slide frame that controls the radial extension of the tire engagement claw shown in FIGS. 1 and 3A.

FIG. 5A is a perspective view of the angle bar mounted control pin assembly that underlies the slidably adjustable slide frame illustrated in FIG. 5.

FIG. 5B is a perspective view of the control pin stabilizer plate through which the stabilizer pins protrude as shown in FIG. 3A.

FIG. 6 is a perspective view of a hanger lever adapted for temporary attachment to the lever latch plate formed on the periphery of the base plate shown in FIG. 2A to assist suspension of the assembly as shown in FIG. 1 on the periphery of a tire to facilitate the imposition and tightening of the tire claws over the periphery of the tire treads.

FIG. 6A is a perspective view of a handled socket wrench for tightening the assembly retention bolts that retain the control plate superimposed over the base plate with the radially extensible claw members adjustably slidably disposed therebetween.

FIG. 7 is a perspective view of the gear control cone-end bolt assembly used to lock the control plate in a selected rotational position to lock the tire engagement claws to the circular periphery of an associated tire.

FIG. 7A is a perspective view of the cone-end bolt assembly of FIG. 7 shown apart from the assembly.

FIG. 7B is a side elevational view of the cone-end bolt assembly of FIG. 7 shown apart from the assembly.

FIG. 7C is a perspective view of the cone-end bolt assembly shown in FIGS. 7A and 7B.

FIG. 8 is a plan view of the base assembly shown in FIG. 2A with the control plate of FIG. 2 superimposed over the base assembly and showing the outer ends of the slidably adjustable slide frames projecting beyond the peripheral edges of the base plate and control plate.

### BACKGROUND OF THE INVENTION

A number of good and tested apparatus have been patented to date as indicated by the prior art listed above. However there are some common weaknesses that appear in most of these devices, for example: sensitive springs, gear systems and many other sensitive parts. The life spans of these parts are highly questionable under brutal conditions like snow mixed with salt, sand and mud, which is the reality of winter driving. No doubt when these parts get corroded, repair or replacement will be needed. There are thousands of small towns located far from big cities that would make it difficult for these folks to find needed parts in the middle of a winter storm season. What would happen if the parts were not available is that while most of the prior art devices claim to be very simple, a close examination reveals just the opposite of that, resulting in the inability to repair the prior art devices. Many of these prior art devices have simple working procedures but they are made of expensive and difficult to reproduce parts that only the original manufacturer could easily reproduce some of these complicated parts. For example, especially formed parts with machine-cut gear teeth in them, or gears with square holes in their centers; springs that are made to specifications; or parts injection molded and not easily replaceable. There are many other small parts in the prior art devices that are very costly or impossible to reproduce in small shops.

The present invention thus cuts across or effectively eliminates these problems. The simple to reproduce parts used to fabricate the present apparatus makes it possible to repair it or reproduce its parts efficiently in machine shops or weld shops of any small town in the country.

As to the effectiveness of this and other tested devices: this problem has been approached in many different ways as indicated in the prior art listed above. But it would be difficult to imagine a more effective way to cut through stubborn ice that is frozen to the surface of the roadway than to use the abutting sharp edge of an inverted 90° angle “V” bar claw. While the double back side edges of the “V” bar claw grab the rubber on the tire, some portion of these back side edges extend into the recesses between treads of the tire, which then make it impossible for the inverted “V” bar claws to slip in relation to the tires. An added benefit from the use of double walled “V” bars or claws is the sturdy construction that it creates. It is questionable how many of the above listed prior art devices could stand up to high-power V-8 engines like 357 Chevy Van or 6.2 or 6.5 V-8 power engines or, for that matter, the many other V-8 trucks and vans traveling ice covered roads all over the country. The double wall construction of the above said “V” shaped angle bar is particularly well-suited to service high-power engines as well as passenger cars.

U.S. Pat No. 5,223,058 suggests that the base disk remains attached to the rim during the winter months. This suggests that the disk is used on the wheels at normal city or highway speeds. Even if it was possible to perfectly balance the wheel with that extra weight it is questionable how long it would stay that way bouncing in pot holes or scraping the curb of sidewalks while parking. It should be noted that out of balance wheels could damage the treads on tires or, even worse, it could damage the bearings in the wheels. The present invention is easy and fast to install and to remove. One cannot drive at high speeds on snow or on icy roads, so balancing the device is not really needed, however provisions are provided so that the device of the present invention can be balanced if the need arises. Also, with some minor modifications, the present invention can be secured to the rim with the lug nuts but there is no need for this change because the present structure and method of mounting the device only on the periphery of the tire worked quite satisfactorily during testing.

Because of the versatile nature of the apparatus illustrated and described it can be used with four claws as well as with eight claws without modification. None of the above listed prior art devices can make such a claim. While the use of an eight claw apparatus is most effective as tested on icy roads, a four-claw arrangement is faster to install and less expensive if purchased in that form. If the vehicle is stuck in deep snow or mud, the apparatus with four claws can be installed easily and fast to free the vehicle without lifting it up with a jack as is required to install conventional gear.

U.S. Pat. No. 4,122,880 suggests that by increasing the gripping members, it increases the device's complexity. It will also increase the time involved in attaching these members to the tire and also adds extra weight to the vehicle's wheels. The above stated problems have been dealt with successfully by the present invention, which enables the use of tire-engaging claws but the installer can use only four claws or as many as eight if necessary or desirable. The radially extending slots in the control plate work the same way with eight claws as they would with four claws and it does not present any additional complexity but only a little extra weight but modern cars are more than capable to exert enough power to carry a little extra weight if added traction is required in a given circumstance.

U.S. Pat. Nos. 6,341,635B1 and 5,735,980 use telescopic springs or small fingers that extend into the back side of the tire to hold the device in place and radial adjustment is used. U.S. Pat. No. 6,619,353 B1 illustrates and teaches a complex way to hold the generally rectangular friction members in place. No doubt the above devices would do well on paved roads under normal conditions but when heavy snow or ice covers the surface of the road the user may not be able to tell where the pavement ends and the device may be forced to withstand an unpaved narrow frozen road that could test even the most sturdy mechanism. Driving under the said rough winter conditions can put great demand on anti-skid devices. The apparatus forming the present invention that is illustrated and described herein was designed to meet these extreme winter conditions. A user can purchase extra wide claws for his large pickup truck and if he wants to use the same device with the same claws on a small passenger car he can do so by inserting a small inexpensive space filler into the back end of the claws. This space filler is hidden and protected from the rough surface of the road between the solid “V” shaped claws and the surface of the tire. The present apparatus has been tested many times on rocky roads. Such a sturdy device can handle the roughest and the worst road conditions even if the biggest V-8 engine powers it.

There are a great number of patented anti-skid devices as listed above. They all claim to be sturdy, simple and practical to use. However, the present invention challenges the said devices by its simplicity to repair it or replace defective parts. It also challenges the above listed prior art devices in their life span and practicality to be effective in the function for which they were designed.

### DESCRIPTION OF THE PREFERRED EMBODIMENTS

The purpose of the apparatus shown in the drawings, when applied to the periphery of the driving tires of a vehicle, be it a passenger automobile, a pick-up truck, a flat bed or cargo truck or a bus for passengers, is to provide spaced transverse abutments across the periphery of the tire that dig into the snow, earth or mud when the tire rotates so as to propel the vehicle forward or backward as the need may be. Because of its design, it may easily be applied to the tire and locked in place without exertion of a great deal of force. Generally, the various parts of the apparatus will be referred to herein by appropriate reference numbers also indicated in the drawings.

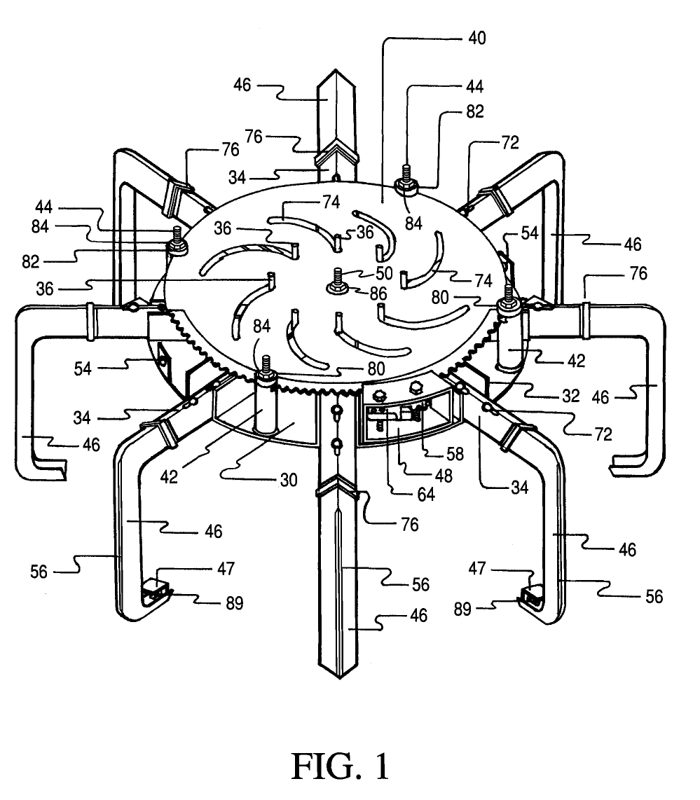

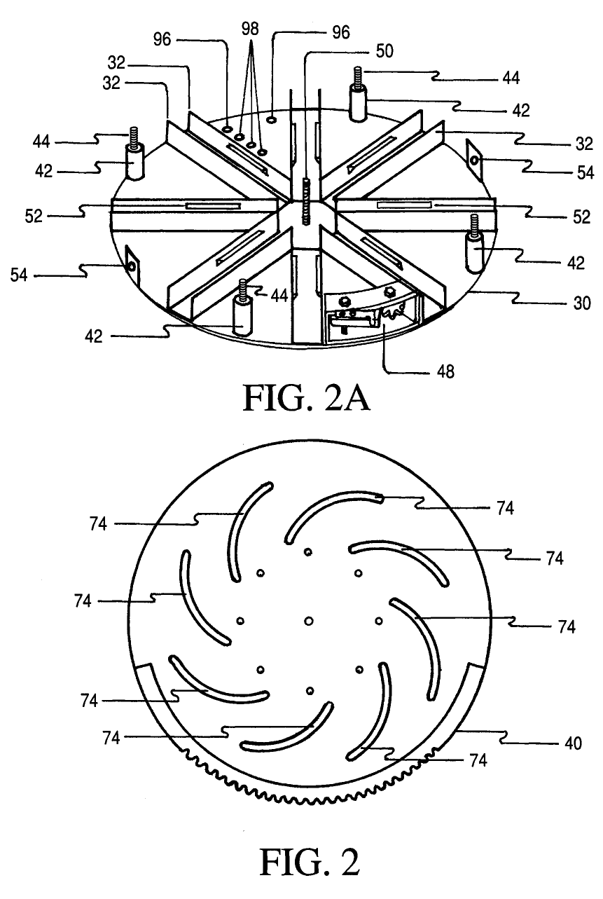

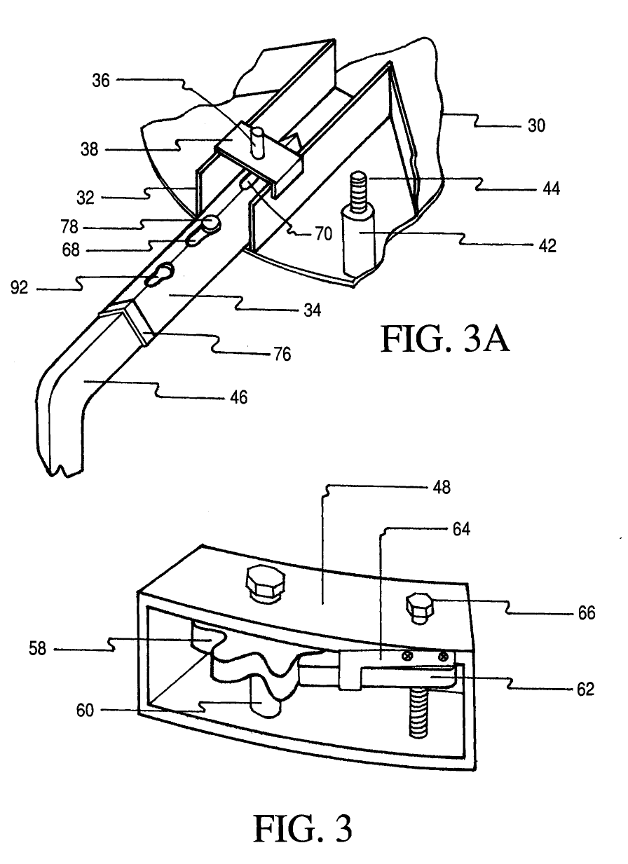

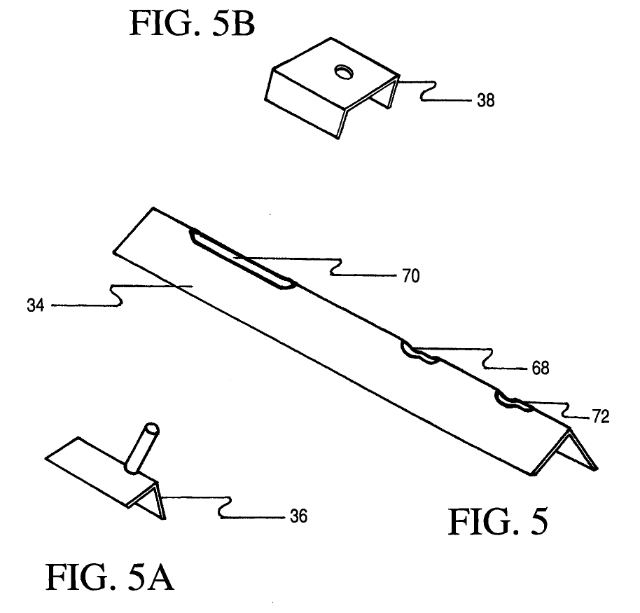

Referring to the drawings, initially to FIGS. 1, 2 and 2A, steel plate 30 serves as a strong backing plate able to withstand the force imposed by powerful V-8 engines. Metallic channel guides 32 (FIG. 2A) are superimposed on the surface of and welded to backing plate 30 at eight intervals angularly spaced forty-five degrees apart. However, a stress relieved 4140 aluminum base plate with channel guides riveted thereon would be sufficiently strong enough to do the same job as steel plate 30 and would also be practical. It should be noted that channel bars 32 are comprised of steel to form the upwardly opening channel bars shown in FIG. 1A. Two identical right angle bars turned face-to-face to form a U-shaped bar by welding the abutting edges of the two right angle bars and on both outside edges welding the right angle bars to the base plate would serve the same purpose. Metallic channel guide bars 32 serve to hold the entire unit together. Consistent tolerances of 0.005″ to 0.010″ are required in the channel guide to accommodate sliding angle bar 34, which, as shown in FIG. 3A and FIG. 5, is superimposed within channel guide 32 and is a movable part that moves constantly inside of channel guide 32 while the apparatus is in use. Slidable angle bar 34 must slide freely in the channel guide between specific limits as will hereinafter be explained.

Referring to FIG. 1, eight claws are shown, but using four claws may have some advantages over the eight claws under specific circumstances. For example, if the vehicle is stuck and the tires spinning in mud, snow or ice, the user can quickly install the apparatus with only four claws and cause the vehicle to move promptly. Using four claws has other advantages. Base plate 30 can be made available with only four channel guides 32 instead of eight and the control plate 40 can also be produced with only four arcuate radially extending slots 74.

That in itself creates more advantages, especially for the budget-minded user. An apparatus with four claws can be produced for less expense than a unit with eight claws. Additionally, it will be much faster to install and faster still to remove, and also, less work for the user and less weight to carry around. On the other hand, a unit with eight claws is a more effective anti-skid device. Additionally, because the apparatus is a versatile mechanism, a user can purchase the unit with eight claws but selectively, whenever it is an advantage, use it with only four claws when it is more convenient to the user. The radially extending curved or arcuate slots in control plate 40 have the unique property of functioning exactly the same way with four claws as they do when eight claws are used.

Referring to FIGS. 1, 3A, 5, 5A and 5B, slide rod 34 comprises a 90° steel angle bar that is 7.20″ long and has first and second specially configured slots spaced apart along the crest of the angle bar and a third simple elongated slot formed along the crest of the angle bar spaced from the intermediate slot and adapted to slidably receive a control pin 36′ welded to and underlying the slide rod 34. As illustrated in FIG. 5A, the slide control member 36 comprises a short 90″ angle bar of smaller size than the angle bar 34 and lies beneath the angle bar 34 and above the angular extension of claw member 46. To retain the slide control member 34 slidably disposed on the radially extending claw support portion that extends radially between the vertical sides of the slide channels 32, the outwardly projecting control pin portion of the slide control member 36 passes snugly through an aperture in pin stabilizer plate 38 the opposite ends of which slidably lap over the upper edges of the channel guides 32 as shown in FIG. 3A.

The stabilizer plate 38 is formed from a thin steel plate that fits slidably over the vertical sides of the associated channel,guide like a floating washer and functions to follow and hold the control pin portion axially aligned along the center of the channel guide 32. Because of the stress these parts have to bear during the operation of the unit and the constant movement that sliding rod 34 accommodates it is preferred that these parts be made out of high quality or heat-treated steel angle bar. To this end, sliding rod at 34 is provided with three elongated slots 68,70 and 72 in FIGS. 3A and 5, all of which are spaced along the apex of sliding angle bar 34. The slot is a combination of a ⅜″ wide slot with a 9/16″ hole in the inside end of the slot which is referred to as a “quick-change slot”. Slot 70 is an elongated slot that holds and guides control pin 36 (FIG. 3A) along with pin stabilizer plate 38. Slot 72 is identical to slot 68 and will be discussed at greater length hereinafter.

The detailed functions of the slots 68, 70 and 72 are as follows. As has been said above, the angular slide rod 34 must be allowed to move freely between the upright walls of the channel guides and so does the control pin assembly 36 which must be allowed free movement in relation to slot 70. A normally inflated tire can and will ingress approximately ½″ to ¾″ in the area where it contacts the surface of the road as a result of the weight of the vehicle it must support. These constant movements in the tire were anticipated and accommodated during the design and construction of the apparatus. Thus, the main function of elongated slot 70 is to make it possible for the tires to freely ingress and outgress as the surface of the road dictates to assure a smooth continuous movement of the angular slide rods 34 in the unit during rotation of the tires. By contrast, while many patented anti-skid devices use various types of springs to solve this “movement” problem, the present invention does not use any springs because the salted surface of the road and mud would quickly corrode and erode springs and render them useless. The present invention takes advantage of the natural elasticity and movements of the tire to achieve the above said function by virtue of slot 70, which accommodates repositioning of the control pin assembly 36. All of the parts in this apparatus are stable, i.e. none move during the function of the apparatus in use except the sliding angle rod 34 and claw members 46 that underlie angle rod 34. The basic principle and the working of this apparatus can best be seen in FIGS. 1 and 3A.

Included in the control pin assembly 36 is a heat-treated steel pin 36′ welded into the body of a 90° angle bar element: The angle bar body of the control pin assembly 36 is similar to 90° angle bar 34 but it is considerably smaller, i.e. small enough to fit loosely and slidably under the angular slide rod 34. The steel pin 36′ is inserted through slot 70 (FIG. 3A) then through stabilizer plate 38 (FIGS. 3A and 5B) and finally it fits slidably into the arcuate radially extending slot 74 in control plate 40 (FIGS. 1, 2 and 8). Thereby, the said parts are held together and allowed to move unrestricted in the arcuate radially extending slots 74.

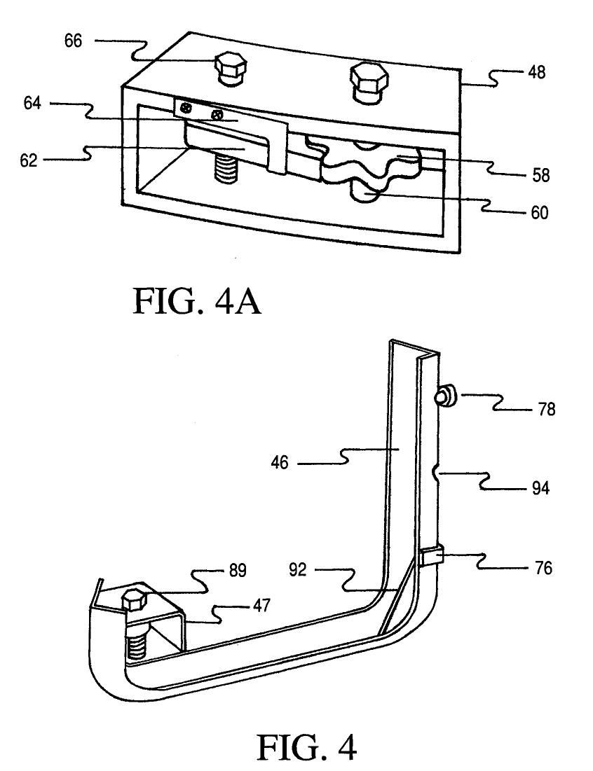

The slot 68 functions as a “quick change slot” because it holds and connects slide rod 34 and claw 46 (FIGS. 3A and 4). An aperture is formed through the apex of the radially extending end of claw 46 to accept a 90° cone-headed bolt fitted through the aperture into the 90° underside cavity of the claw and permanently secured thereto from two sides by welding in the 90° underside cavity. The threaded end of the bolt passes upwardly out on the apex edge aside of the 90° angle bar as shown best in FIG. 4. A head having an outer diameter to fit through the 9/16″ hole in slot 68 is welded on the outer exposed end of the bolt to form a knob 78 (FIGS. 3A and 4). When slide rod 34 is assembled onto underlying claw 46, the head or knob 78 slips through the 9/16″ aperture in angle bar 34 and then the bolt will slide down into the ⅜″ slot 68, thereby creating a “quick change” for claw 46. The above cone-headed bolt functions to secure the assembly. In fact, the claws cannot be disengaged from the slot unless the apparatus is opened up by removal of the control plate and the claws are repositioned to align the knob with the 9/16″ hole or aperture whereupon the knob slides through the aperture to disconnect the angular slide rod from the underlying angular portion of the claw. The cone-head bolts are readily commercially available but the head of such bolt can easily be formed into a 90° angle on a lathe if for some reason they are not commercially available. Slot 72 functions as an extension slot and is identical in shape and size to adjacent slot 68 discussed above that is formed between slots 70 and 72. The straight end portion of claw member 46 interlocks into the underside of angular slide rod 34 about 4-½″, the combined strength of the two overlapped angle bars make this unit very strong and dependable even under the most strenuous conditions and can best be seen in FIG. 3. Thus, when the knob 78 is relocated from slot 68 by applying it to extension slot 72, it will slightly change the configuration by virtue of the extension of the claw radially outward to accommodate a tire of larger diameter. Prior to this repositioning of the knob into the slot 72, the opening and closing range of the claws is up to about five inches to accommodate a variety of tire sizes. However, when extension slot 72 is used it will increase the opening and closing range to seven inches on the diameter. This is achieved by making slot 68 identical to slot 72 and positioning them one inch apart, whereupon a 4-½″ interlock becomes a 3-½″ interlock.

Alternatively, by adding a tapped hole 94 (FIG. 4A) into claw arm 46 under the extension slot 68, the two parts can be held together tightly, with a ⅜″ threaded bolt that screws into the tapped hole 94 and the strength of the assembly will remain intact, however, by doing this, the “quick change” facility of the claws will be eliminated. For this reason, extension slot 72 comprises an option, for use by a person who owns both a passenger car and a larger wheeled pickup truck to enable him or her to use this apparatus on either of the vehicles.

Control plate 40 (FIG. 2) is preferably a ⅛″ thick circular steel plate that symmetrically overlies the circular base plate 30 and channel guides 32 thereon and is retained in this relationship by a central aperture 41 that fits over the central bolt 50 the distal end of which is welded in the center of the base plate 30. The central aperture in control plate 40 is ½″ in diameter and snugly yet slidably receives bolt 50, the lower end of which is secured in a central aperture in the base plate 30 and welded thereto from the underside of the base plate 30. Control plate 40 (FIG. 2) has eight radially extending arcuate slots 74 formed into it. Each slot is formed with a 3″ radius and are spaced 45° apart with the inner and outer ends of the slots spaced equally spaced, respectively, from the outer periphery and center of the control plate. These locations are held to close tolerances. The lengths of slots 74 determine the uniform range of the opening and closing of the claws over the tires through control of the positions of the control pins 36 that slidably penetrate the respective slots.

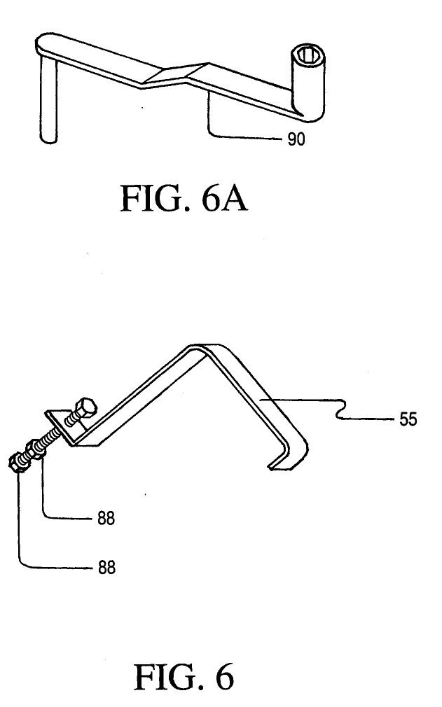

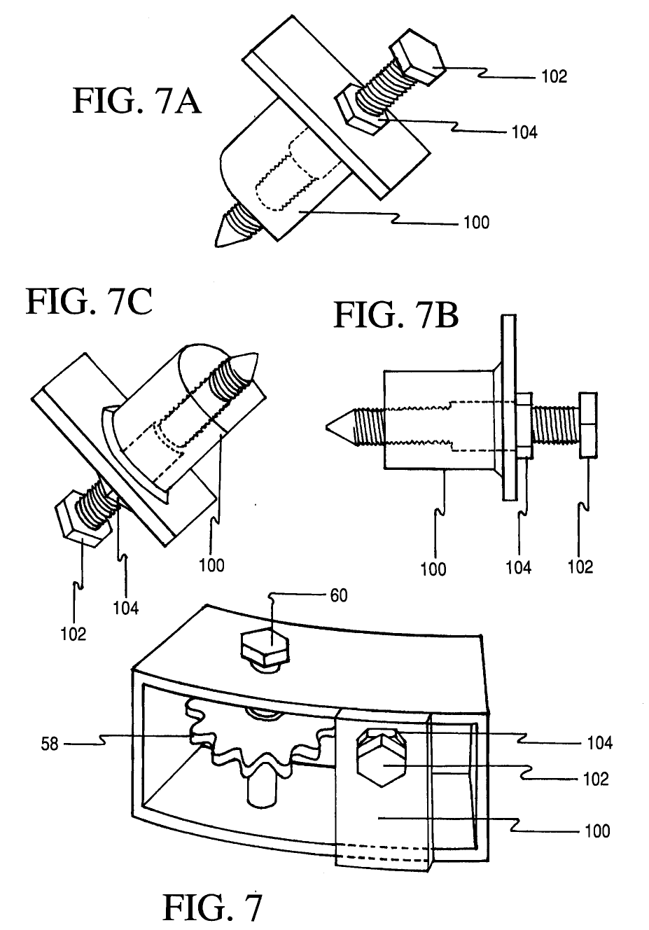

Control plate 40 (FIG. 2) possesses gear teeth as illustrated and as it is turned or rotated by gear mechanism 48 (FIGS. 1, 2A, 3, 4A and 7), it will equally squeeze and tighten all the claws simultaneously onto the periphery of the tire. It will be seen that gear 58 is mounted on shaft 60 which is provided with a hex head 60′. To effect control, a handle assembly 90 (FIG. 6A) is provided having a hexagon socket 90′ that engages the hex head 60′. When rotation of the handle assembly is effected shaft 60 will turn gear 58 and the gear 58 will turn control plate 40, which then sets the control pins 36 in motion to open or close the claws 46, depending on the direction of rotation of handle 90. Handle 90 is designed to be sufficiently strong to apply the required pressure on the gear system to set the control pins in the proper position to effect a clamping force on the claws or to release the claws when required.

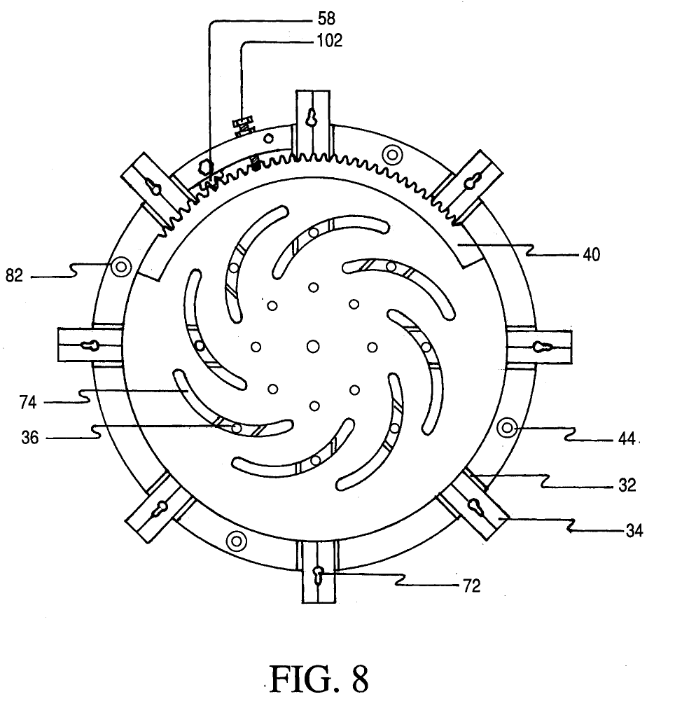

Referring to FIGS. 2 and 8, when control plate 40 is rotated clockwise the arcuate radial slots 74 are also rotated clockwise, resulting in control pins 36 being forced radially inwardly toward the center of the apparatus so as to shift the claws into a tightening direction or position. It should be noted as viewed in FIG. 2, the control plate 40 illustrates radial slots 74 inclined radially outwardly to the “right” or clockwise direction and that the control plate 74 in this attitude should be mounted on the right or passenger side tire so that the slots are inclined in the direction the “right” or passenger wheel turns. However, when the apparatus is to be mounted on the left rear or front tires, i.e., on the driver's side of the vehicle, the control plate is flipped over and mounted on the apparatus so that the slots 74 again are inclined in the direction in which the tire rotates when the vehicle is moving forward. Stated in other words, when properly mounted on the rear or front driving wheels, as on a four wheel drive vehicle, the apparatus, including the control plate, rotates “clockwise” on the right or passenger side wheel or wheels but rotates “counter-clockwise” on the left or driver's side rear and front wheels.

During testing it was determined that the apparatus worked just as well on the “left” (driver's side) wheel and the “right” (passenger-side) wheels to force the pins 36 into a tightening position so that the forward motion of the wheels will keep the pins 36 in a tight position at all times. Because the slots 74 in control plate 40 are symmetrical, flipping the plate over when mounted on the driver's side, the slot's orientation become the mirror image of the slots on the passenger side of the vehicle and they will be turning to the “left” or forwardly or “counter-clockwise” when mounted on the left wheel or wheels to achieve the same effect as is achieved on the “right” or passenger-side wheel or wheels.

Eight holes 43 shown formed in control plate 40 perform the function of tooling aids during machining and define the centers of curvature for radial slots 74. It should be noted that when arcuate slots 74 are formed in the control plate on a computer controlled milling machine these apertures or holes would not be needed.

Referring to FIGS. 1, 2 and 2A, it will be seen that four spacers 42 are mounted on the base plate 30 at 90° intervals. Spacers 42 may be formed from solid metal rod stock having a length sufficient to project slightly beyond the height of the upper or free edges of the channel guides 32 when the opposite end of the spacer is welded or otherwise mounted adjacent the peripheral edge of the base plate so that the outer periphery of the spacer coincides with the outer periphery of the base plate 30 as shown. When fabricated from solid metal rod, the spacer is machined to provide a ⅜″ threaded extension on its upper end. The threaded extension is of sufficient length to overlap the peripheral edge of the control plate which rests on the upper ledge of the spacer surrounding the threaded extension. Alternatively, the spacer may be formed of tubular stock to receive the ⅜″ bolt 44 the bottom end of which is welded to the base plate along with the bottom end of the tubular stock so that the upper threaded end of the bolt projects sufficiently beyond the upper surface of the control plate 40 as shown in FIG. 1 so as to receive a washer 82 and a nut 84. In either case, a peripheral portion of the control plate 40 rests on the upper flat end of the spacer so that in four locations a peripheral edge portion of the control plate is clamped tightly against the upper ends of the spacers. To reduce the weight of the apparatus, metals such as aluminum or even titanium could be substituted for steel.

Referring to FIGS. 1, 2A and 4A, the gear control assembly 48 illustrated therein is applicable to a “snow spike” apparatus adapted for mounting on a driving tire mounted on the “left” or driver's side of a vehicle. The gear assembly 48′ shown in FIG. 3 is adapted for mounting on an apparatus to be mounted on the “right” or passenger side of the vehicle. In either case, the gear assembly includes an open-ended “box” 48 having tapered end walls to fit between the vertical sides of two adjacent channel guides 32 to which the “box” is appropriately welded. It should be noted that the back side of the base plate 30 is kept flat, free of projecting nuts or other obstructions of any kind that could damage expensive magnesium wheels or rims if such nuts or obstructions came into contact therewith. For instance, central threaded bolt 50, conveniently ½″ in diameter and 2″ long is securely welded to the center of the flat front face of circular base plate 30 which is preferably 15″ in diameter and ⅛″ thick between its circular front and rear faces.

Having thus described the invention, what is believed to be new and novel and sought to be patented is set forth in the claims hereinafter presented.

What is claimed is:

1. A tire traction-enhancing apparatus for detachable attachment to the tread surface of a tire on which it is mounted for enhancement of the traction between the tread surface and the terrain on which the tire tread surface is supported for rotation about an axis of rotation, said traction-enhancing apparatus comprising:
a) a base plate having a central axis and a peripheral edge spaced radially from said central axis and a mounting bolt fixed perpendicularly to said base plate at said central axis;
b) a plurality of elongated spacer support pins attached perpendicularly to a surface of said base plate by one end thereof adjacent the outer periphery thereof and spaced circumferentially thereabout, a portion of each said elongated spacer support pin being threaded at its end remote from said base plate;
c) an elongated spacer having a central bore superimposed on each spacer support pin and having a length shorter than the associated pin whereby a threaded portion of the associated support pin projects beyond the end of said spacer remote from said base plate whereby the end surfaces of said spacers are equidistant from said base plate and collectively provide flat support surfaces below the threaded end portions of the spacer support pins, the opposite ends of said spacers impinging on the associated surface of said base plate;
d) a plurality of circumferentially spaced elongated channel guides immovably attached to the surface of said base plate from which said spacer support pins extend, said channel guides each extending from adjacent said central axis of said base plate to the peripheral edge thereof and including a pair of laterally spaced parallel side walls extending perpendicularly from the surface of said base plate;
e) a radially adjustable assembly confined within each said circumferentially spaced elongated channel, each said radially adjustable assembly including:
e(1) a first relatively short angle bar disposed in each channel guide, the lateral edges of which angle bar are slidably disposed between the side walls of the associated channel guide whereby the apex of said angle bar is spaced from said base plate and medianly spaced between said channel guide and is provided with an elongated control pin fixed to said apex intermediate the ends thereof and which control pin projects beyond the upper edges of the parallel walls forming said channel guide;
e(2) a second relatively longer angle bar slidably superimposed over said first relatively short angle bar and having an elongated slot in the apex thereof adjacent one end thereof through which slidably projects the control pin fixed to and projecting from the apex of said first relatively short angle bar, the elongated slot in the second relatively longer angle bar and the angle bar portion in which said elongated slot is formed being positioned within the outer periphery of said base plate and a second relatively longer angle bar having a second shorter slot formed in the apex thereof spaced from said first mentioned elongated slot and lying beyond the outer periphery of said base plate, said second shorter slot having an enlarged aperture at one end thereof;
e(3) a claw member including an angle iron mounting portion and an angle iron tire-engaging portion extending at right angles to each other, said angle iron mounting portion having a retention head adapted to project through said enlarged aperture of said second shorter slot formed in said second relatively longer angle bar when said mounting portion of said claw is conformably slidably disposed on said second relatively longer angle bar whereby said mounting portion of said claw is locked to said second angle iron when said mounting portion is slid relative to said slotted second angle bar to shift said retention head along said slotted angle bar whereby the retention head of the mounting portion of the claw overlies the narrower portion of the slotted second angle bar when the tire engaging portion is extended to overlie and grasp the tread of the tire on which the apparatus is mounted;
e(4) a control plate detachably mounted on said mounting bolt fixed perpendicularly to said base plate at the central axis thereof, peripheral edge portions of said control plate resting on upper end portions of said elongated spacers projecting from said base plate whereby secure means overlapping spaced peripheral edge portions of said control plate retain the control plate rotatably secured to said base plate;
e(5) a plurality of circularly arranged radially outwardly curved slots formed in said control plate and adapted to slidably receive the upper end portions of said control pins mounted on the apices of said first relatively short angle bars slidably disposed ion said channel guides and projecting through the elongated slot formed in said claw member and the slot in the second angle bar and projecting through an aperture in a slidable stabilized cap mounted on the upper edges of the channel guide and upon which said control plate rests;
e(6) gear teeth on a portion of the outer periphery of said control plate; and
e(7) a gear control assembly disposed between the outer ends of a pair of adjacent channel guides and fixed to said base plate and including a rotatable gear meshing with the gear teeth on the periphery of said control plate and including a spring pressed gear lock lever associated with said gear and applicable to automatically retain the gear in the position to which it has been rotated to forcibly tighten and retain the tire engaging claw members clamped to the peripheral tread portion of the tire.

2. The apparatus defined in claim 1, wherein said base plate has a circular periphery.

3. The apparatus defined in claim 1, wherein said mounting bolt is welded at one end to the base plate and extends perpendicularly therefrom to present a threaded end portionk spaced from said base plate.

4. The apparatus defined in claim 1, wherein said plurality of spacer support pins are equally spaced adjacent the periphery of said base plate.

5. The apparatus defined in claim 1, wherein each said spacer is welded to one surface of said base plate.

6. The apparatus defined in claim 1, wherein said elongated channels are generally U-shaped.
